(19) United States
(12) Patent Application Publication
(10) Pub. No.: US 2017/0317421 A1
(43) Pub. Date: Nov. 2, 2017

(54) Low Profile Wideband Planar Antenna Element

(71) Applicant: L-3 Communications Corporation, New York, NY (US)

(72) Inventors: Maurio Batista GRANDO, McKinney, TX (US); Heath KEENE, Plano, TX (US)

(73) Assignee: L-3 Communications Corporation, New York, NY (US)

(21) Appl. No.: 15/143,421

(22) Filed: Apr. 29, 2016

(51) Int. Cl. H01Q 9/28; H01Q 1/50; H01Q 1/48

(52) U.S. Cl. CPC H01Q 9/285; H01Q 1/48; H01Q 1/50

(57) ABSTRACT

An antenna assembly for use in a tile architecture antenna system. The antenna assembly comprises: i) a first substrate layer having a first surface and a second surface; ii) a plurality of electromagnetic band gap (EBG) patches disposed on a first surface of the first substrate layer; iii) a second substrate layer having a first surface and a second surface, wherein the second surface of the second substrate layer is disposed on the first surface of the first substrate layer and on the plurality of EBG patches; iv) an antenna disposed on the first surface of the second substrate layer; and v) a transceiver circuit disposed proximate the second surface of the first substrate layer, wherein the transceiver circuit provides an output signal to be transmitted by the antenna.

### CROSS-REFERENCE TO RELATED APPLICATION

The present application is related to U.S. patent application Ser. No. ______ entitled “Low Profile Wideband Planar Antenna Element With Integrated Baluns” filed concurrently herewith. Application Ser. No. ______ is assigned to the assignee of the present application and is hereby incorporated by reference into the present application as if fully set forth herein.

### TECHNICAL FIELD

The present application relates generally to antennas and, more specifically, to a wideband bowtie planar antenna element.

### BACKGROUND

Current advanced radar systems favor highly integrated designs in order to reduce cost and to aid in the manufacturability of complex systems. As a result, tile architecture antenna designs are highly desirable implementations. However, one drawback to tile architecture antenna designs is the bandwidth of such antennas. Another drawback is that driving a tile architecture antenna with a differential signal from an integrated circuit (IC) requires a single-ended to double-ended balun. Most antennas in tile architectures require a considerable height or length in the “Z” direction to provide the required bandwidth. This inherently limits the integration of a tile architecture antenna design into multiple components: 1) the antenna, 2) the balun, and 3) the electronics.

Low profile wideband antennas are commonly desired for conformal and highly integrated antenna designs. Most wideband antennas (e.g., notch antenna, Vivaldi antenna) require some amount of height in the Z-direction in order to provide the necessary bandwidth. So called “bowtie” antennas are also able to provide a large amount of bandwidth and may require less height in the Z-direction. But, in order to be used in a practical array, these bowtie antennas require a ground plane in order to direct radiation in one hemisphere. This requires that the bowtie antenna be a quarter wavelength (λ/4) from the ground plane. This requirement severely limits the bandwidth.

There are limited options for planar antenna designs with wide bandwidth that can be fabricated with a simple printed circuit board (PCB) process. One solution that is not planar and involves an extended fabrication process is the vivaldi “egg crate” array. However, this requires a complex interface to the radio frequency (RF) electronics to sum array elements in cross dimensions or to add dual polarization capability. Also, the required height in the Z-direction to obtain broadband performance prevents a low profile solution necessary for many applications. Implementations like the vivaldi with antenna designs that require card like interfaces are difficult to integrate and fabricate. At some point, the antenna design must transition to a planar substrate and this complicates integration by requiring the manufacturing process to join two or more physically separated sections.

If the antenna were itself planar and made using traditional PCB manufacturing processes, this would allow for a highly integrated design that is simple to fabricate and manufacture. Prior art publications have disclosed that placing a bowtie antenna over an electromagnetic band gap (EBG) material allows for the bowtie antenna to keep its impedance bandwidth while preserving the pattern performance in that band. But, while the EBG material satisfies the Z (height) condition, the additional requirement of needing a balun adds complications to the design. Baluns proposed in conventional designs require micro-strip Wilkinson designs or twin lead transmission lines along the Z-direction of the substrate.

Also, given a tightly packed array, a planar solution for a balun is not always possible. Currently, the industry solution is to develop a planar balun and then orient the balun perpendicular to the dipole in order to feed it. However, this creates considerable mechanical issues and may cause reliability and repeatability issues. PCB-mounted differential antennas need an integrated balun that conforms to current PCB processes and leaves a small footprint in order to allow for maximum area to accommodate multiple traces and components.

Therefore, there is a need in the art for an improved antenna designs. In particular, there is a need for improved planar antenna systems that may be implemented using an antenna tile architecture.

### SUMMARY

To address the above-discussed deficiencies of the prior art, it is a primary object to provide, for use in a tile architecture antenna system, an antenna assembly comprising: i) a first substrate layer having a first surface and a second surface; ii) a plurality of electromagnetic band gap (EBG) patches disposed on a first surface of the first substrate layer; iii) a second substrate layer having a first surface and a second surface, wherein the second surface of the second substrate layer is disposed on the first surface of the first substrate layer and on the plurality of EBG patches; iv) an antenna disposed on the first surface of the second substrate layer; and v) a transceiver circuit disposed proximate the second surface of the first substrate layer, wherein the transceiver circuit provides an output signal to be transmitted by the antenna. The transceiver circuit may drive the antenna indirectly through a balun or may drive the antenna directly by means of a differential output of the transceiver circuit.

In one embodiment, the antenna assembly comprises a ground plane layer disposed between the second surface of the first substrate layer and the transceiver circuit.

In another embodiment, the antenna assembly comprises a plurality of electromagnetic band gap (EBG) vias, each of the EBG vias coupling one of the plurality of EBG patches to the ground plane layer.

In still another embodiment, the antenna assembly comprises a feed via that communicates the output signal from the transceiver circuit to the antenna, wherein the feed via passes through the ground plane layer.

In yet another embodiment, the antenna assembly comprises a stack up layer disposed between the ground plane layer and the transceiver circuit.

In a further embodiment, the stack up layer further comprises a balun configured to provide polarization.

In a still further embodiment, the antenna comprises a single dipole antenna.

In a yet further embodiment, the antenna comprises two dipoles antennas in a crossed bowtie antenna configuration.

In one embodiment, the first substrate layer is thicker than the second substrate layer.

In another embodiment, at least one of the first substrate layer and the second substrate layer comprises glass epoxy.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a perspective view of a planar antenna using a dual-polarized, multi-function array structure with a differential output according to one embodiment of the disclosure.

FIG. 2 illustrates a side cross-sectional view of an integrated antenna stackup according to one embodiment of the disclosure.

FIG. 3 is a graph of a voltage standing wave ratio (VSWR) of a tile antenna limited by balun bandwidth according to one embodiment of the disclosure.

FIGS. 4A-4C illustrate the pattern performance of an integrated crossed bowtie antenna element at various frequencies according to exemplary embodiments of the disclosure.

### DETAILED DESCRIPTION

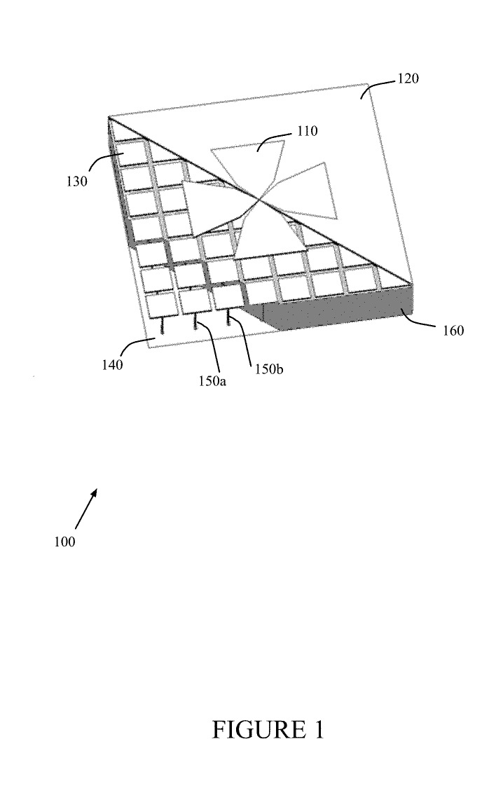

FIGS. 1 through 4A-4C, discussed below, and the embodiments used to describe the principles of the present disclosure are by way of illustration only and should not be construed in any way to limit the scope of the disclosure. Those skilled in the art will understand that the principles of the present disclosure may be implemented in any suitably arranged antenna element.

The present disclosure describes a low profile wideband planar antenna element that may be produced using standard printed circuit board (PCB) etching techniques. Beneficially, this enables the antenna element to be implemented in highly integrated systems in which the antenna element may be part of the radio frequency (RF) stackup layers of the PCB. In the disclosed embodiment, the planar element provides a solution lending itself to highly integrated arrays and communication systems. Similar to a patch, but with far more bandwidth, the disclosed antenna elements may be part of the integrated RF stackup layers and perhaps even the digital stackup layers of the PCB.

FIG. 1 illustrates a perspective (cutaway) view of planar antenna assembly 100 using a dual-polarized, multi-function array structure with a differential output according to one embodiment of the disclosure. Planar antenna assembly 100 comprises antenna 110, thin substrate layer 120, a plurality of electromagnetic band gap (EBG) patches 130, ground plane layer 140, a plurality of electromagnetic band gap (EBG) vias 150, and thick substrate layer 160. Antenna 110 may comprise, by way of example, a crossed bowtie antenna (i.e., two dipole antennas) or a single dipole antenna formed on a first metal layer (Layer 1). In one implementation, such as a radar system, a plurality of antenna assemblies such as planar antenna assembly 100 may be arranged in rows and columns to form an antenna system having a tile architecture.

In an exemplary embodiment, thin substrate layer 120 may be approximately 5 mil (0.005 inches) in thickness and may be formed from a material such as FR4 glass epoxy (e.g., a composite material comprising woven fiberglass cloth with an epoxy resin binder). Also, by way of example, thin substrate layer 120 may be formed from Rogers Corp. RT/duroid 5880 high frequency laminate. In an exemplary embodiment, thick substrate layer 160 may be approximately 30 mil (0.030 inches) or greater in thickness and also may be formed from FR4 glass epoxy or Rogers 5880 laminate. In the cutaway view in FIG. 1, thin substrate layer 120 and thick substrate layer 160 are both shown partially removed in order to illustrate a plurality of rectangular EBG patches, such as EBG patch 130, formed in a second metal layer (Layer 2) and EBG vias 150a and 150b in the second and third layers.

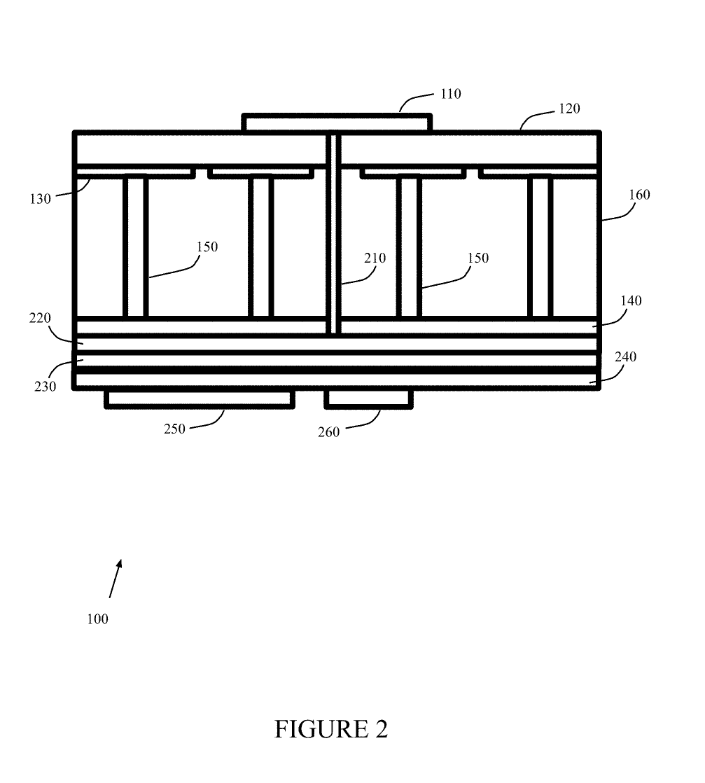

FIG. 2 illustrates a side view of planar antenna assembly 100 according to one embodiment of the disclosure. As FIG. 2 indicates, planar antenna assembly 100 comprises an integrated antenna stackup. In addition to the components already illustrated and described in FIG. 1, antenna assembly 100 further comprises feed via 210, radio frequency (RF) stack up layers 220, 230, and 240, RF circuit 250, and digital circuit 260. By way of example, one or more of RF stack up layers 220, 230, and 240 may comprise micro-strip line Marchand baluns that provide polarization and/or provide transformation from single-ended transmission lines to differential transmission lines. One or both of RF circuit 250 and digital circuit 260 comprise transceiver circuitry configured to generate an output signal to be transmitted by antenna 100 and/or to receive from antenna 100 an incoming RF signal. In some embodiments of the disclosure, a differential transmission line may be used to couple feed via 210 to the transceiver circuitry.

Feed via 210 provides a signal connection from RF stack up layers 220, 230, and 240, RF circuit 250, and digital circuit 260 to antenna 110 through ground plane 140, thick substrate 160, and thin substrate 120. Each of the plurality of EBG vias 150 provides a connection between ground plane 140 and one of the plurality of EBG patches 130. Advantageously, the multilayer nature of planar antenna assembly 100 provides an efficient, reduced-size tile structure for transmitting signals between antenna 110 and RF circuit 250 and digital circuit 260.

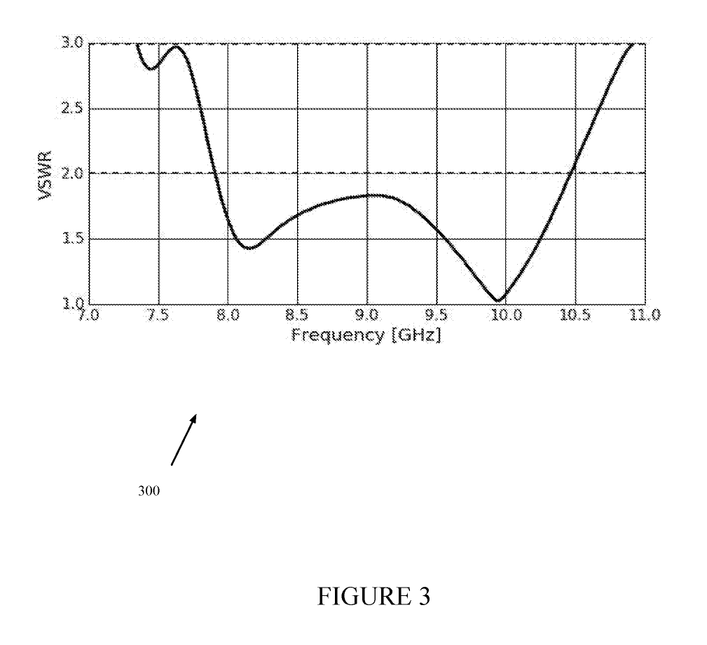

FIG. 3 is a graph of the voltage standing wave ratio (VSWR) 300 of a tile antenna (as shown in FIGS. 1 and 2) limited by balun bandwidth according to one embodiment of the disclosure. The exemplary frequency range is from 7 GHz to 11 GHz. The VSWR range is from 1 to 3.

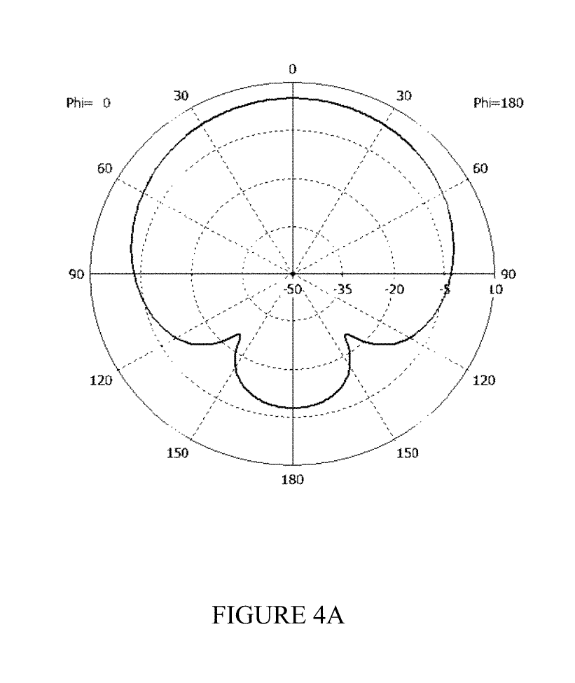

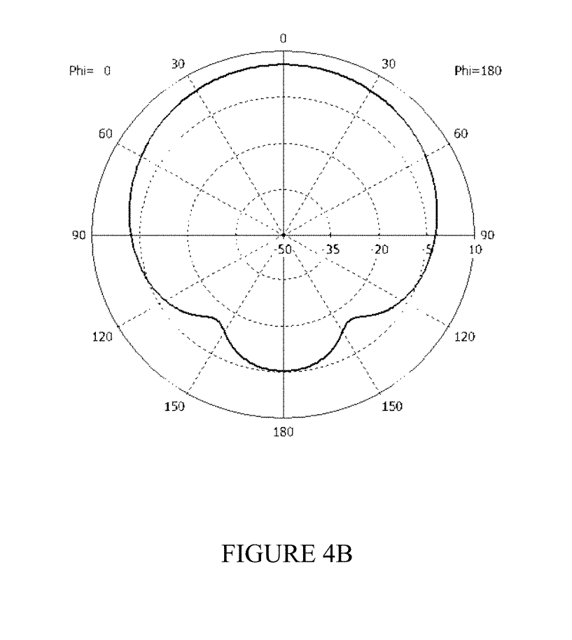

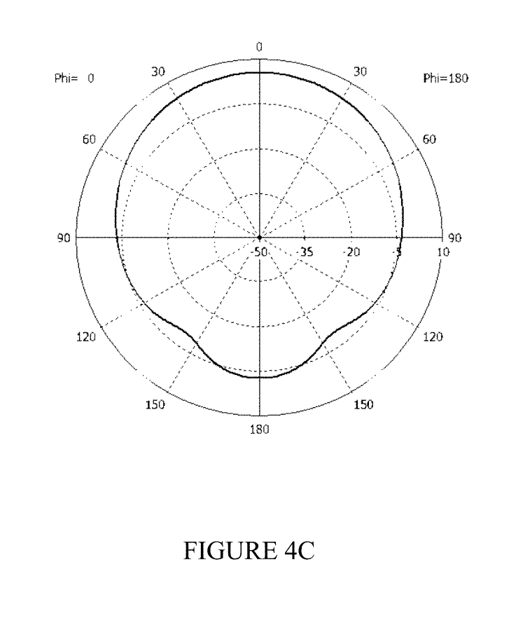

FIGS. 4A-4C illustrate the pattern performance of an integrated crossed bowtie antenna element at various frequencies according to exemplary embodiments of the disclosure. FIG. 4A illustrates the pattern for a crossed bowtie antenna at 8.5 GHz. FIG. 4B illustrates the pattern for a crossed bowtie antenna at 10.0 GHz. FIG. 4C illustrates the pattern for a crossed bowtie antenna at 11.5 GHz.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An antenna assembly comprising:
a first substrate layer having a first surface and a second surface;
a plurality of electromagnetic band gap (EBG) patches disposed on a first surface of the first substrate layer;
a second substrate layer having a first surface and a second surface, wherein the second surface of the second substrate layer is disposed on the first surface of the first substrate layer and on the plurality of EBG patches;
an antenna disposed on the first surface of the second substrate layer; and
a transceiver circuit disposed proximate the second surface of the first substrate layer, wherein the transceiver circuit provides an output signal to be transmitted by the antenna.

2. The antenna assembly as set forth in claim 1, further comprising a ground plane layer disposed between the second surface of the first substrate layer and the transceiver circuit.

3. The antenna assembly as set forth in claim 2, further comprising a plurality of electromagnetic band gap (EBG) vias, each of the EBG vias coupling one of the plurality of EBG patches to the ground plane layer.

4. The antenna assembly as set forth in claim 2, further comprising a feed via that communicates the output signal from the transceiver circuit to the antenna, wherein the feed via passes through the ground plane layer.

5. The antenna assembly as set forth in claim 4, further comprising a stack up layer disposed between the ground plane layer and the transceiver circuit.

6. The antenna assembly as set forth in claim 5, wherein the stack up layer further comprises a balun configured to provide polarization.

7. The antenna assembly as set forth in claim 2, wherein the antenna comprises a single dipole antenna.

8. The antenna assembly as set forth in claim 2, wherein the antenna comprises two dipoles antennas in a crossed bowtie antenna configuration.

9. The antenna assembly as set forth in claim 2, wherein the first substrate layer is thicker than the second substrate layer.

10. The antenna assembly as set forth in claim 9, wherein at least one of the first substrate layer and the second substrate layer comprises glass epoxy.

11. An antenna system comprising:
a plurality of antenna assemblies configured in a tile architecture, each of the plurality of antenna assemblies comprising:
a first substrate layer having a first surface and a second surface;
a plurality of electromagnetic band gap (EBG) patches disposed on a first surface of the first substrate layer;
a second substrate layer having a first surface and a second surface, wherein the second surface of the second substrate layer is disposed on the first surface of the first substrate layer and on the plurality of EBG patches;
an antenna disposed on the first surface of the second substrate layer; and
a transceiver circuit disposed proximate the second surface of the first substrate layer, wherein the transceiver circuit provides an output signal to be transmitted by the antenna.

12. The antenna system as set forth in claim 11, wherein the each antenna assembly further comprises a ground plane layer disposed between the second surface of the first substrate layer and the transceiver circuit.

13. The antenna system as set forth in claim 12, wherein the each antenna assembly further comprises a plurality of electromagnetic band gap (EBG) vias, each of the EBG vias coupling one of the plurality of EBG patches to the ground plane layer.

14. The antenna system as set forth in claim 12, wherein the each antenna assembly further comprises a feed via that communicates the output signal from the transceiver circuit to the antenna, wherein the feed via passes through the ground plane layer.

15. The antenna system as set forth in claim 14, wherein the each antenna assembly further comprises a stack up layer disposed between the ground plane layer and the transceiver circuit.

16. The antenna system as set forth in claim 15, wherein the stack up layer further comprises a balun configured to provide polarization.

17. The antenna system as set forth in claim 12, wherein the antenna comprises a single dipole antenna.

18. The antenna system as set forth in claim 12, wherein the antenna comprises two dipoles antennas in a crossed bowtie antenna configuration.

19. The antenna system as set forth in claim 12, wherein the first substrate layer is thicker than the second substrate layer.

20. The antenna system as set forth in claim 19, wherein at least one of the first substrate layer and the second substrate layer comprises glass epoxy.
